(19) United States
(12) Patent Application Publication
(10) Pub. No.: US 2008/0054733 A1
(43) Pub. Date: Mar. 6, 2008

(54) Slotless Ac Induction Motor

(76) Inventor: Jonathan Sidney Edelson, Portland, OR (US)

Correspondence Address: Borealis Technical Limited, 23545 NW Skyline Boulevard, North Plains, OR, 97133-9205, US

(21) Appl. No.: 11/596,157

(22) PCT Filed: May 11, 2005
(86) PCT No.: PCT/US05/16571

§ 371 Date: Nov. 10, 2006

Related U.S. Application Data
(60) Provisional application No. 60/570,578, filed on May 12, 2004.
(60) Provisional application No. 60/635,767, filed on Dec. 13, 2004.

(51) Int. Cl. H02K 17/00; H02K 15/00

(52) U.S. Cl. 310/42; 310/166; 310/179; 310/91

(57) ABSTRACT

The present invention is a rotating induction motor that is capable of providing higher peak torque than a conventional design, which achieves the shortcomings of the prior art by in regard to iron saturation by a slot-less design; removing the iron slot provides more space for the conductor. The motor comprises a stator and a concentric rotor, separated from the stator by an air gap. The rotor has rotor bars and rotor windings. The stator is slot-less and comprises surface mounted conductors separated from each other by suitable insulation. An advantage of this design is that the motor does not exhibit typical behavior at high currents; there is no saturation effect.

### TECHNICAL FIELD

The present invention relates to windings, teeth and laminations for motors and generators. The present invention relates to torque maximization within limited motor frame dimensions. The present invention also relates to ‘inside-out’ motors in which the stator is co-axial with and internal to the rotor.

### BACKGROUND ART

The magnetic flux generated by the drive current is enhanced by the presence of iron slots on the stator. When flux linkage is plotted versus current for a typical motor winding, the slope of the curve is the inductance. At higher current levels, the inductance falls off rapidly, as the iron is saturated. Eventually, when all of the magnetic domains' are lined up in the same direction, there is almost no more flux generated for increasing current, and the inductance drops dramatically.

Thus, at high current levels when high peak torque is needed, a conventional motor will overload because of saturation effects. In a conventional motor design, at high currents, the subsequent small increase in flux in the saturation region is due to the increase produced by the regions between the dipoles in the iron, which is essentially the same as the magnetic permeability of vacuum.

Looking at the stator core and rotor core, the open slots tend to increase the magnetic reluctance of the air gap, which causes magnetomotive force to be wasted, resulting in decreased efficiency. Moreover, spatial variation of magnetic flux density in the air gap is increased, which may cause vibration and noise.

Various attempts have been made in the prior art to improve ironless core armature performance. For example, U.S. Pat. No. 3,944,857 to Faulhaber discloses an air-core or ironless core armature for electrodynamic machines having an elongated insulating strip rolled up to form a spiral structure composed of a number of radially successive layers. An armature winding is comprised of at least one armature coil and each coil is comprised of a number of electrically interconnected component coils. Each coil is formed of electrically interconnected conductor sections printed on both sides of the insulating strip. This set up, unfortunately, does not optimize the configuration of the windings so as to produce optimal torque.

U.S. Pat. No. 3,805,104 to Margrain is directed to a hollow insulating cylinder with conductors which are placed over an internal metallic tubular support which is supported by an end disk at one end, and open at the other end, the open end being flared for stiffness. The cylinder has insulation with the electrical conductors being in printed or laminated circuit form. This type of device, however, compromises the conductor packing density factor and does not produce optimal torque.

U.S. Pat. No. 6,072,262, to Kim, entitled “Slot-less motor for super high speed driving” describes a DC slot free motor utilizing permanent magnets. U.S. Pat. No. 4,103,197, to Ikegami, et al., entitled “Cylindrical core with toroidal windings at angularly spaced locations on the core” is directed to a core structure and a method for inserting toroidal windings around a hollow cylindrical core without the need for special equipment, for use in a DC motor. U.S. Pat. No. 4,843,269, to Shramo describes a DC motor with pancake windings encircling rotor axis, the rotor incorporating a number of permanent magnets, and the system designed for optimal heat removal. U.S. Pat. No. 5,313,131 to Hibino, et al. describes formed coils and their specific distribution within a permanent magnet slotless DC motor.

U.S. Pat. Nos. 6,111,329 and 6,598,065 and U.S. Patent Application Pub. No. 2003/0020587, to Graham and Yankie disclose an ironless core armature for a D.C. motor with brushes. The armature has a conductive coil constructed from a pair of precision-machined rectangular metal sheets or plates, copper or copper alloy, cut in a pattern to produce a series of generally parallel conductive bands with each band separated from the other by a cut-out. This servomotor aims to eliminate both hysteresis and cogging torque by eliminating magnetic materials in the stator that can distort, demagnetize, or saturate with peak currents. This approach aims to deliver enhanced performance by improving upon the limitations of wire-wound stators. The standard copper magnet wire of conventional motors has been replaced with multiple precision-machined copper plates, thus eliminating the need for iron lamination.

Whilst this approach may offer advantages in direct current (DC) and permanent magnet (PM) designs, there remains a need in the art to provide an AC induction motor that provides high torque at high current levels without limitations imposed by iron saturation in the airgap.

An increased airgap enabling high torque causes an increased motor size and the airgap itself generally involves wasted space. There remains a need in the art to provide a large airgap without increasing the dimensions of an AC motor.

### DISCLOSURE OF INVENTION

From the foregoing, it may be appreciated that a need has arisen for a compact, high torque induction machine allowing for maximum torque production within a reasonably small system mass and providing stable inductance curves.

In broad terms, the present invention is an alternating current (AC) induction machine having a first support which comprises an external frame supporting a first electrical member, and having a second support that is internal to and coaxial with the first support and which comprises a core supporting a second electrical member, and in which at least one of the supports is slotless. One of the electrical members is a stator having at least three phases, and the other electrical member is a rotor.

In a second embodiment, the current-carrying elements are bar shaped and are mounted directly onto the surface of the core and/or outer supporting frame.

In a third embodiment, coatings or bars are arranged on or between the current-carrying elements to increase the flux of the generated magnetic field. Conductor coatings of a soft magnetic high flux alloy, for example and without limitation, Hiperco™ 50, may be used.

In a fourth embodiment, the induction machine has an ‘inside out’ design in which the rotor is external to the stator. This is particularly useful in direct drive applications, usually requiring the high torque of the present invention.

In a fifth embodiment, the enhanced capabilities of a mesh-connected polyphase motor system are harnessed to provide the high levels of torque required when moving from stationary or low speed, and for providing low levels of torque at higher speeds.

An advantage of the present invention is that the absence of slots on the stator, the rotor, or both elements increases the size of the airgap, and allows conducting elements to be placed in the airgap. Thus, at high torque densities, an increased airgap tends to allow an increase in torque-producing current without a commensurate increase in the magnetizing current.

A further advantage of the present invention is that in the absence of iron slots, the induction machine does not exhibit typical behavior at high currents; there is reduced saturation effect. In addition, heat generated from overload can be better conducted away than from the coils conventionally used. The motor has improved current carrying abilities.

A further advantage of the present invention is that the slotless design means that more space remains for conductors. The greater the conductor mass, the greater the generated currents and torque may be.

A further advantage of the present invention is that the outer motor dimensions need not be correspondingly large. Additionally the core diameter may be increased, providing an improved flux distribution. The core may have holes to reduce mass.

According to design considerations, copper conductors may replace some, all, or none of the mass typically devoted to iron teeth.

### BRIEF DESCRIPTION OF DRAWINGS

For a more complete explanation of the present invention and the technical advantages thereof, reference is now made to the following description and the accompanying drawings, in which:

FIGS. 1a and 1b show a diagrammatic representation of a cross-sectional view of a first embodiment of the present invention;

FIG. 2 shows a diagrammatic representation of a cross-sectional view of another embodiment of the present invention;

FIG. 3 shows a diagrammatic representation of a cross-sectional view of a third embodiment of the present invention;

FIGS. 4a-b show a diagrammatic representation of a cross-section of several embodiments of the present invention;

FIGS. 5a-c show a diagrammatic representation of a cross-section of further embodiments of the present invention;

FIGS. 6a-b show a diagrammatic representation of a mesh connected winding.

### BEST MODE FOR CARRYING OUT THE INVENTION

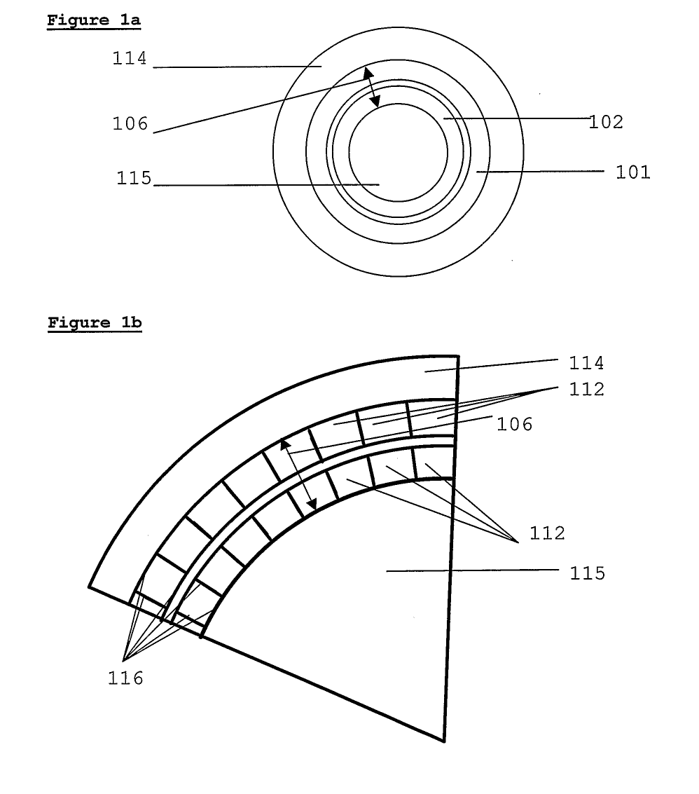

Embodiments of the present invention and its advantages are best understood by referring to FIGS. 1 though 6 of the drawings, like numerals being used for like and corresponding parts of the various drawings.

In the following, the term induction machine is to be understood as to include both induction motors and generators.

With reference to FIG. 1a, an AC induction motor is provided, according to a first aspect of the present invention, two electrical members are provided, outer electrical member 101 and inner electrical member 102. In the ensuing description, the term “electrical member” is used generically to refer to either the rotor or the stator. Electrical members perform the usual functions of rotor and stator but are not limited in relative position by the present invention to either rôle. Either stator or rotor may be external to the other. The electrical members each contain conductors connected according to standard winding configurations. Two toothless supports are provided, outer frame 114, and inner core 115. The term “support” is used in the ensuing description as a generic term to mean either an outer motor frame or an inner concentric motor core. Each of frame 114 and core 115 supports an electrical member. The support to the rotor permits axial rotation as is well known in the art. Since the supports do not have teeth, airgap 106 extends between core 115 and frame 114, to include the region filled by the electrical members.

FIG. 1b shows details of the toothless AC induction machine shown in FIG. 1a. The machine consists of two concentric slotless supports, outer frame 114 and core 115, neither of which are equipped with teeth. External electrical member 101 comprises a number of conductors 112 mounted on the surface of slotless frame 114. Internal electrical member 102 comprises a number of conductors 112 mounted on the surface of slotless core 115. Conductors 112 are electrically insulated by insulation 116, and are connected together according to standard winding configurations. The magnetic portions of core 114 and frame 115 are separated by airgap 106. A slotless support has the benefits of additional conductor space, reduced airgap saturation and potentially improved machine dimensions.

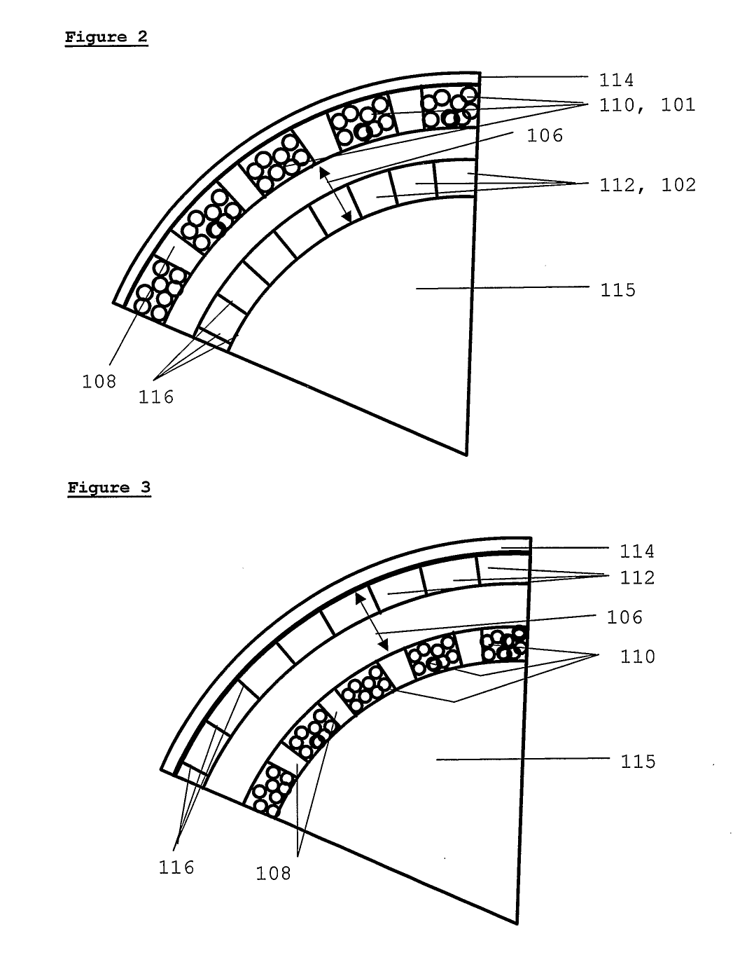

FIG. 2 is a diagrammatic representation of a cross-section of a segment of a slotless AC induction machine according to a second aspect of the present invention, in which airgap 106 is smaller than in the embodiment shown in FIG. 1b. The machine comprises two concentric supports, namely outer frame 114, and core 115. External electrical member 101 comprises standard coils 110, wound around teeth 108 of frame 114, and core 115 is slotless. If external electrical member 101 is serving as the rotor, it may contain standard rotor bars. Internal electrical member 102 comprises conductors 112 mounted on the surface of slotless core 115. Conductors 112 are electrically insulated by insulation 116, and are connected together according to standard winding configurations.

FIG. 3 is a diagrammatic representation of a segment of a cross-section of a slotless AC induction machine according to a third aspect of the present invention, in which airgap 106 is smaller than in the embodiment shown in FIG. 1b. The AC induction machine consists of two concentric supports, namely a slotless outer frame 114, and a core 115. External electrical member 101 comprises a number of conductors 112 mounted on frame 114. Internal electrical member 102 comprises a number of coils 110 wound around teeth 108 of core 115. If internal electrical member 102 is serving as the rotor, it may contain standard rotor bars. Conductors 112 are electrically insulated by insulation 116, and are connected together according to standard winding configurations.

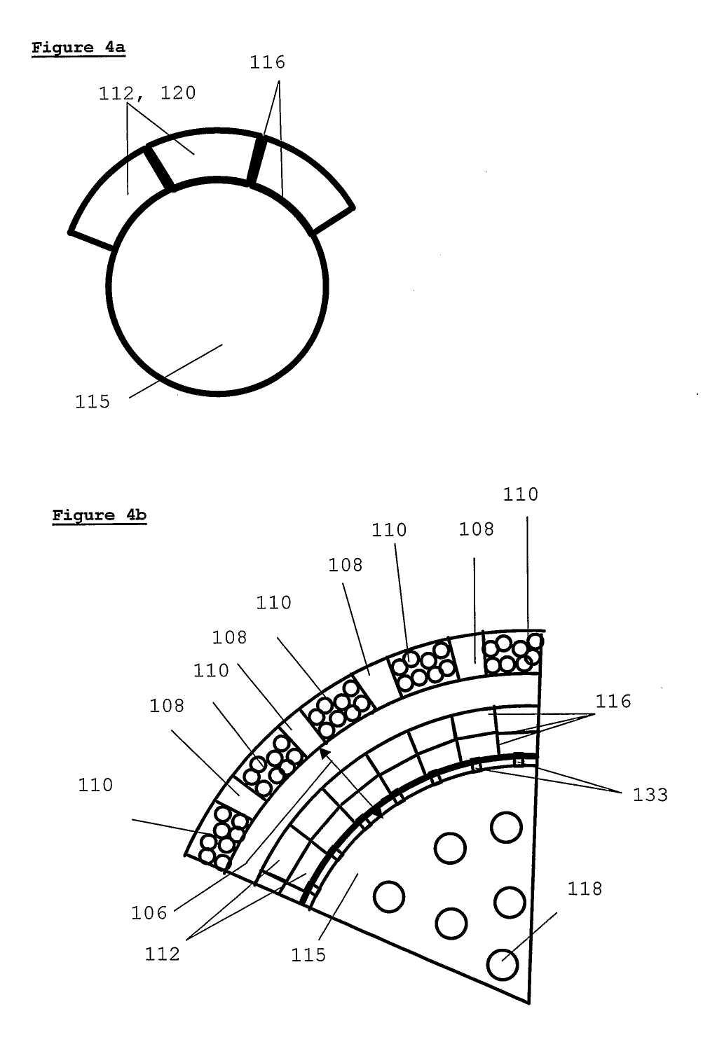

FIG. 4a is a cross-sectional view of an induction machine of FIGS. 1-3, and conductors 112 are formed as insulated bars mounted on a slotless support. Only a few conductors 112 are shown, and with exaggerated size and curvature, to improve clarity. In this embodiment, conductors 112 are structured as rounded trapezoids 120. A benefit of rounded trapezoids 120 over a rectangular cross-section lies in reduced drag, and improved fit on a curved support. Conductors 112 mounted on the slotless support may take any form such as solid bars, coiled windings, smoothed corners, aerodynamically shaped, wiring, coils, rotationally symmetrical, rotationally asymmetrical, regular, irregular, following a distribution, skewed around a support axis, and spiraled around a support axis. Insulation 116 prevents the conductors 112 from electrically contacting one another, and preferably completely coats conductors 112.

FIG. 4b is a cross-sectional view of part of a further embodiment of the slotless design of the present invention. Core 115 is slotless. Internal electrical member 102 comprises insulated conductors 112 arranged in a stacked configuration, allowing a high ratio of active current carrying components. The stacked configuration would be equally applicable to either slotless support. Conductors 102 are joined by end turns to form a winding configuration with multiple turns per phase.

In the foregoing, conductors 112 may be mounted on the slotless support in any way known in the art, including but not limited to gluing, machining, winding, soldering, joining with an arm, ducts, etc. In one embodiment, shown in FIG. 4b, conductors 112 are attached to core 115 with short arm 133. Arm 133 allows air circulation between conductors 112 and core 115.

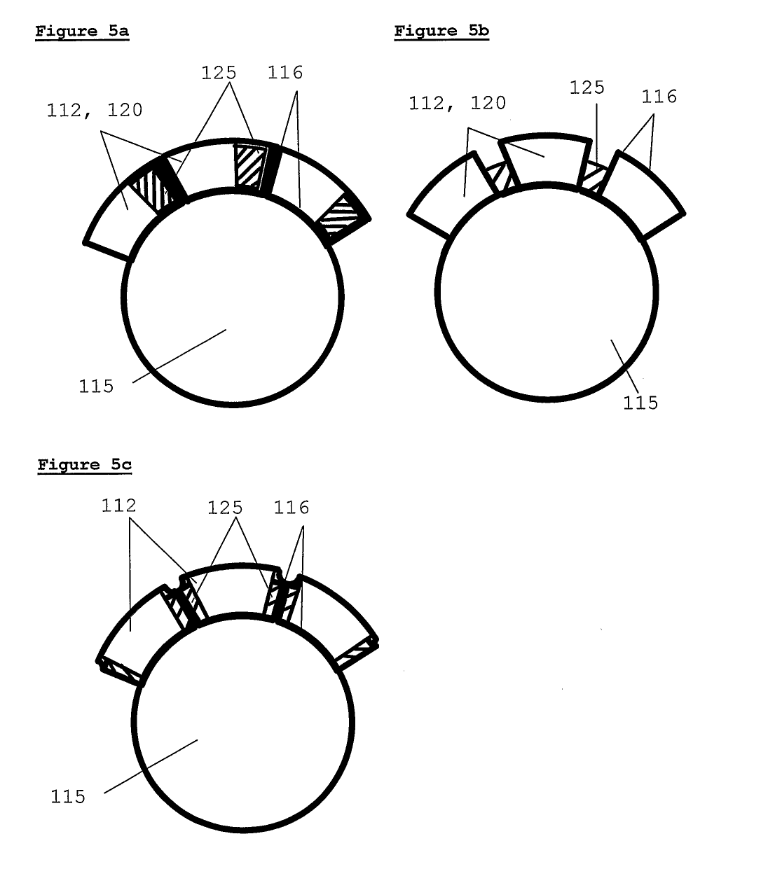

The slotless supports shown in FIGS. 1-3 may be built with high flux material around the conductors, in structures other than as slots, for example as iron bars. The benefit of iron in the region is that the magnetic flux produced by the conductors is increased by its presence. FIG. 5a shows slotless core 115 upon which conductors 112, structured as rounded trapezoids 120, are mounted. A high flux material 125, is added between conductors 112 and insulation 116 to one rotational side of each conductor 112. The high flux material 125 could be an iron bar, or another high flux metal, or an alloy such as Hiperco 50.

FIG. 5c is a cross-sectional view of a further embodiment in which conductors 112 are electrically insulated by insulation 116. High magnetic flux material 125 is positioned between conductors 112, outside insulation 116 covering conductors 112.

An airgap between magnetic materials of a motor is typically less than 5/100 inch (Airgap 106 is a feature of FIGS. 1-3, and is measured between the magnetic materials of core 115 and frame 114). The present invention allows the width of the airgap to be increased to between 5/10 and 2/10 inch. This is desirable in applications requiring very high peak torque, since a small airgap prevents peak torque producing current from going through the machine. A large airgap allows greater torque producing current without requiring excessive magnetizing current. The slotless electrical members 101 and/or 102 may be considered as positioned within the airgap since they provide substantially magnetic airgap properties. It is anticipated that the gap between the electrical members be as small as can be mechanically maintained. Outer motor dimensions need not be correspondingly increased to provide a large airgap.

In some applications, a balance may be reached between creating a large airgap by eliminating iron in the region, versus the desirable magnetic properties of iron near the conductors. FIG. 5b shows an embodiment of the present invention, in which magnetic flux material 125 is provided between conductors 112. Magnetic flux material 125 is applied to slotless core 115 between conductors 112 but is shallower than conductors 112. As a result, the airgap is increased over that of a standard toothed motor while the magnetic flux in the region is also enhanced. High magnetic flux material 125 may be a solid iron bar, laminations, or an alloy such as Hiperco.

FIG. 5c is a cross-sectional view of a further embodiment in which a soft alloy of high flux material 125 is added to both sides of conductors 112, to improve magnetic flux in the region. This embodiment prevents against bimetallic bending. The high flux material 125 does not extend to the same height as conductors 112, enabling the airgap to be large. Insulation 116 preferably performs the additional function of housing the alloy. Alternatively a separate housing is used. Housing must be sufficiently rigid to maintain the alloy's structure and protect it from deformation throughout the temperature range of motor operation. Insulation 116 also protects against leakage electrical current, and provides rotational symmetry of conductors 112 and high flux material 125.

In a further embodiment, instead of or in addition to increasing the airgap width, the slotless design allows the core and frame to be built closer to one another. The outer frame may be smaller than in a toothed design. Alternatively, the diameter of core 115 may be increased, providing an improved flux distribution, within the same external motor dimensions. To reduce mass, core 115 may be hollowed, or may comprise holes 118, as shown in FIG. 4b. Holes 118 may be drilled into core 115 or alternatively, core 115 may be formed by stacking laminations containing holes 118.

The above designs of FIGS. 4a-b and 5a-c should be seen as exemplary and should not be seen as limiting the invention in any way. The various modifications may be applied in combination or in isolation, and to any of the slotless supports and electrical members of FIGS. 1, 2 and 3 as required. Conductors 112 may be formed of any current carrying material, preferably copper, aluminum or silver, and may be formed as insulated bars, wiring, or coils. Conductors 112 may assume any shape and proportions known in the art, such as rectangular, trapezoidal, curved, with smoothed corners, otherwise aerodynamically shaped, etc., they may also be skewed or spiraled around an axis of the core or the frame, instead of stretching longitudinally down the support. Conductors 112 and/or high flux material 125 may be built with rotational symmetry, or with rotational asymmetry. They may have proportions and/or spacing to follow any desired distribution, particularly beneficial in a machine with a low phase count.

The present invention simplifies motor winding, since windings need not be fed through slots. As mentioned with reference to FIG. 4b, the conductors may be stacked, and may be several layers deep. If the conductors are formed as coils or wire, it is much easier to wind a machine without having to fit the wires in between teeth. In very powerful motors, for example a 20 megawatt machine, a single conductor bar per phase may be enough. In smaller motors, like a 5 hp machine, a few conductors must be connected together.

The end turns of the motor may be made in any way known to the art, for example, if the conductors are made of wire, the end turns may be simply wrapped around the motor ends, or glued or zigzagged. Alternatively, a machined end piece could be provided to connect conductors. The invention is not limited to any particular type of end turn production.

The present invention improves the ratio of conductor to insulator in the machine. In a standard slotted motor, this ratio may be as low as 45% due to the limitations involved in winding wiring through slots. In the slotless design of the present invention, the ratio may be very high.

The AC motor of the present invention described herein may be any type of induction motor or generator, including a squirrel cage, wound rotor etc. It may also be an axial flux machine, a LIM, or a pancake, etc. The present invention is not limited to specific types of windings; for example, a lap winding may be simpler to construct than a wave winding. The machine may also be toroidal. This may have particular benefit as the toothless design makes the machine very easy to wind. The windings may be rectangular wire wrapped around the stack. Wrapping the coil around the outside of the stator in this fashion leads to a design that is easier to wind, has better phase separation, and allows independent control of the current in each slot, thus eliminating cross stator symmetry requirements. This design may lead to an ‘end turn’ which is longer or shorter. Thus, in a large two pole machine, the end turn is otherwise quite large, the utilization of conductor material will be much reduced: n a conventional two pole motor, the end turns are easily longer than the wires in the slots, so even if the ‘back side’ conductors are not used, they might simply be much shorter ‘end turns’. For example, a 2 pole machine having a slot length of 4.5″, but a mean turn length on the order of 40″, has 75% of the wire in the ‘end turn’, and the end turn is very bulky, requiring a shorter lamination stack.

If the machine has a low phase count, such as three or four phases, it is often a benefit to have distributed windings. Although in the Figures above, the conductors are shown as regularly spaced and shaped, they conductors may instead be asymmetrically proportioned and/or distributed. This aids in eliminating undesirable harmonics, and has other benefits.

Of particular benefit is a high-phase order motor, in which more than three different phases are used. Preferably only one conductor is used per phase per pole. The benefit of high phase order machines is that they harness temporal harmonics enabling increased torque within the same motor frame and drive electronics.

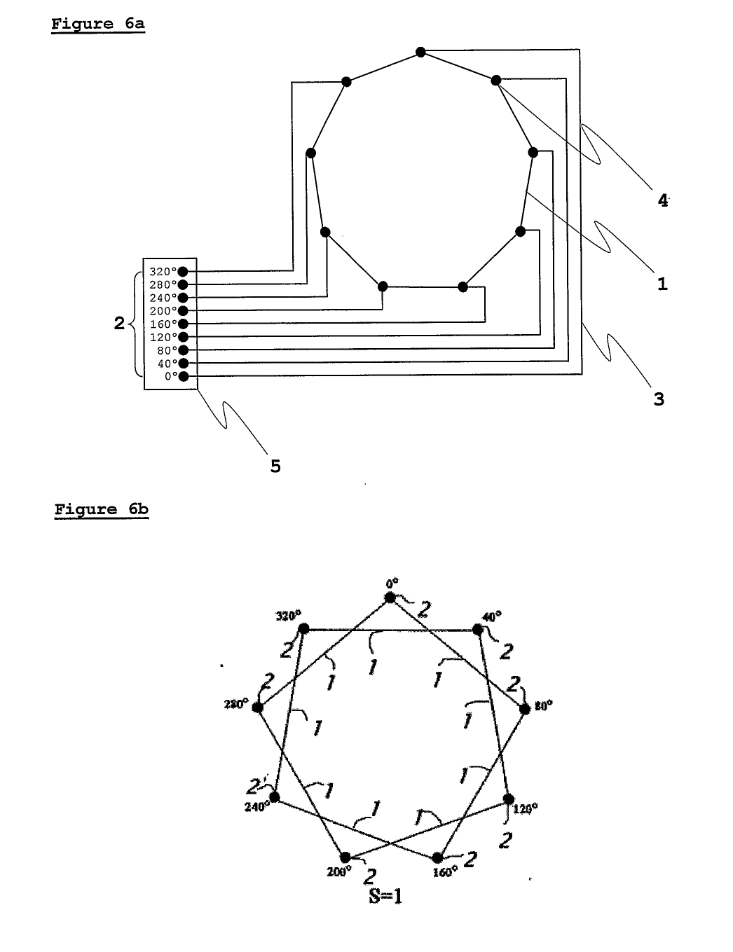

In a further embodiment, the slotless design of the present invention is used in a high phase order mesh-connected motor of the kind described in U.S. Pat. No. 6,657,334. Referring now to FIG. 6a, a mesh-connected drive schematic is provided. The stator of the present invention comprises either conductors 112, or coils 110. These are grouped to form N ‘windings’ 1, where N is the number of windings 1 per pole, in the instant example N=9, and inverter 5 provides nine output phases 2, with a forty degree phase offset. Windings 1 form a mesh-connection 4, meaning that each winding 1 is connected to two different inverter phases 2. The voltage across a winding 1 is given by the vector difference in voltage of the two inverter phases 2 to which the winding 1 is connected.

Referring now to FIG. 6b, the mesh connection 4 is differently arranged so that each winding 1 is connected between a different two of the nine inverter phases 2, to achieve a variety in relative phase angles. If the smallest degree in relative phase angle between inverter output terminals is termed a winding span of L=1, and there are N different phases in the machine, winding spans may be selected between L=0 (star connection) and L=N. FIG. 6b represents the L=2 connection, whereas FIG. 6a represents the L=1 connection, and is not dissimilar to a three phase delta connection. Winding spans L vary the impedance of the motor, and may be selected according to motor requirements.

A further benefit to mesh-connected motors is electronic impedance changes, since altering the harmonic content of the inverter output with any given winding mesh-connection has the effect of varying the motor effective connectivity. These changes in effective connectivity permit high current overload operation at low speed, while maintaining high-speed capability, without the need for contactors or actual machine connection changes. In other words, the inverter drive is capable of effectively changing the volts/hertz relation of the motor, thereby producing a variable impedance motor.

Mesh-connected motors are of particular benefit to the present invention because the present invention teaches the use of solid conductor bars forming one or both of the electrical members and the inverter led impedance control thus extends the operational envelope of the machine.

A machine, especially a toroidal machine, may be wound with a standard number of turns, and then have flexibility of phase count. The machine is wound according to the following method.

A slotless support is provided, preferably for the stator. The different required phase counts are determined, and a number N is calculated, in which N is a multiple of all the required machine phase counts. A wire is wound with N turns around the slotless support. An inverter drive is provided to drive each phase. If a high phase count is required, the N turns are evenly distributed amongst the phases. If a low phase count is required, the N turns may be unevenly distributed amongst the phases.

For example, a machine is wound with 360 continuous turns or wire, and is intended as a four pole machine. The machine can then be used with any number of phases that is a divisor of 90, for example as a 15 phase machine, a 9 phase machine, or a 5 phase machine. For a star connection, or a mesh connected winding with a mesh in which L>1, the continuous winding will need to be cut, and connected to the appropriate inverter outputs. If a mesh connection of L=1 is to be used, the continuous winding will not need to be cut, and the inverter outputs simply need to be connected to the winding according to the phase distribution. In addition, if the winding does not require cutting, the phase count may be varied during operation by reconnecting the inverter to a different turn count per phase.

While this invention has been described with reference to numerous embodiments, it is to be understood that this description is not intended to be construed in a limiting sense. Various modifications and combinations of the illustrative embodiments will be apparent to persons skilled in the art upon reference to this description. It is to be further understood, therefore, that numerous changes in the details of the embodiments of the present invention and additional embodiments of the present invention will be apparent to, and may be made by, persons of ordinary skill in the art having reference to this description. It is contemplated that all such changes and additional embodiments are within the spirit and true scope of the invention as claimed below.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

### Industrial Applicability

A particular application for the present invention is in compact motors such as those situated inside the wheel of a vehicle, providing for the high torque requirements within limited dimensions. An inside-out system, featuring an external rotor may be preferable to provide wheel drive—the rotor may form part of the wheel hub. With a mesh-connected motor, the system may be used to provide direct drive at high speed, or a reduced speed drive having higher torque. The present invention also finds applicability in many compact environments requiring high torque.

1. In an alternating current (AC) induction machine
wherein a first support comprises an external frame supporting a first electrical member, and
wherein a second support is internal to and coaxial with said first support and comprises a core supporting a second electrical member, and
wherein one of said electrical members comprises a stator comprising at least three phases, and the other electrical member comprises a rotor;
the invention characterized in that: at least one of said supports is slotless.

2. The AC machine of claim 1 wherein only one of said supports is slotless and wherein the other support comprises slots, and the electrical member attached thereto comprises windings.

3. The AC machine of claim 1 wherein said slotless support supports said stator, and wherein said stator comprises conductors mounted on said support, and wherein said rotor comprises rotor bars.

4. The AC machine of claim 1 wherein both supports are slotless.

5. The AC machine of claim 3 wherein said rotor is external to said stator.

6. The AC machine of claim 1 wherein said electrical members comprise conductors comprising proportions selected from the group consisting of:
rectangular bars, rounded trapezoids, smoothed corners, aerodynamically shaped, wiring, coils, rotationally symmetrical, rotationally asymmetrical, regular, irregular, following a distribution, skewed around a support axis, and spiraled around a support axis.

7. The AC machine of claim 1 further comprising a high flux material between said conductors, wherein said high flux material is selected from the group consisting of: iron, high flux metal, Hiperco, Hiperco 50, and high flux alloys.

8. The AC machine of claim 7 wherein said high flux material coats said conductors on at least one rotational side and wherein insulation surrounds each of said coated conductors.

9. The AC machine of claim 12 wherein said high flux material is provided in a position selected from the group consisting of: under insulation covering each of said conductors, outside insulation covering said conductors, coating said conductors, to one rotational side of each conductor, to both rotational sides of each conductor, extending only a portion of the conductor height from the support, extending the full conductor height, symmetrically distributed, and asymmetrically distributed.

10. The AC machine of claim 1 wherein an airgap between said frame and said core is substantially between 5/100 and 2/10 of an inch.

11. The AC machine of claim 1 wherein said core comprises one or more holes to reduce weight.

12. The AC machine of claim 1 further comprising end turns joining each electrical member into a winding configuration.

13. The AC machine of claim 12 wherein said electrical member comprises insulated conductor bars stacked around said support and wherein said winding configuration comprises multiple turns per phase.

14. The AC machine of claim 1 wherein said machine is selected from the group consisting of: induction motors, induction generators, lap wound machines, wave wound machines, squirrel cage induction machines, wound rotor induction machines, linear induction machines, pancake machines, toroidal machines, and high phase order induction machines.

15. The AC machine of claim 1 wherein said electrical member supported by said slotless support is attached with a method selected from the group of: adhering, attaching via an arm, affixing said electrical member to end bells attached to said support, and coupling said electrical member to said support.

16. The AC machine of claim 1 wherein the winding configuration of said stator comprises more than three different phases connected to said inverter in a mesh connection, and wherein said inverter is operable to alter the harmonic content of the stator phases, in order to control the volts/hertz ratio of the machine.

17. A method for winding the slotless support of the AC machine of claim 1 to provide machine phase count flexibility, comprising the steps of
a) winding a wire N times around the slotless support, where N is a multiple of all machine phase counts required; and
b) distributing the turns into phases according to a required phase count; and
c) connecting an inverter drive output to each phase.

18. An alternating current induction machine comprising a slotless support;
stator conductors mounted on said support configured with at least three different electrical phases; and an inverter for supplying electrical current to said stator conductors.

19. The alternating current induction machine of claim 18 wherein said machine is a motor, and wherein said stator conductors are configured with N different phases arranged in a mesh connection, where N is more than three, and wherein said inverter operable to alter harmonic content of said electrical current, whereby altering the volts/hertz ratio of the motor.

20. The alternating current machine of claim 19 further comprising a high flux material mounted on said support between said stator conductors.
